(19) United States
(12) Patent Application Publication
(10) Pub. No.: US 2005/0012286 A1
(43) Pub. Date: Jan. 20, 2005

(54) Shopping cart and method of use

(76) Inventor: Arthur F. Woodrow, Tucson, AZ (US)

Correspondence Address: PROCOPIO, CORY, HARGREAVES & SAVITCH LLP, 530 B STREET, SUITE 2100, SAN DIEGO, CA, 92101, US

(21) Appl. No.: 10/622,984

(22) Filed: Jul. 18, 2003

(51) Int. Cl. B62B 3/00

(52) U.S. Cl. 280/47.35

(57) ABSTRACT

An improved shopping cart includes a shopping cart frame supported by a plurality of wheels for rolling the shopping cart around a store, a removable shopping cart basket supported by the shopping cart frame and including a bottom located at a height H that is above a height C of a surface of the checkout stand for receiving shopping items in the removable shopping cart basket.

### FIELD OF THE INVENTION

The present invention is in the field of shopping carts.

### BACKGROUND OF THE INVENTION

Shopping carts are used to assist a shopper in holding and transporting items to be purchased during and after shopping. A standard shopping cart generally includes a deep shopping cart basket fixedly supported by a frame, a handle extending upwardly and rearwardly from a rear part of the basket or frame for pushing the shopping cart, and four casters or wheels that support the deep shopping cart basket and/or frame for rolling movement of the shopping cart. A problem with the standard shopping cart is that the shopping cart basket is too deep, making the insertion of shopping items into the basket and the retrieval of shopping items from the deep basket physically challenging and sometimes dangerous for some individuals, especially when retrieving shopping items from the basket in a narrow lane between checkout stands.

### SUMMARY OF THE INVENTION

Accordingly, an aspect of the invention involves an improved shopping cart including a shopping cart basket removably attached to an elevated support structure of a shopping cart. The removable shopping cart basket is preferably supported by the elevated support structure at a height H slightly higher than the height C of a conveyor belt at a shopping checkout stand. A distal portion of the removable shopping cart basket also preferably hangs over the distal end (front end) of the elevated support structure. The shopping cart may include a disengageable holding mechanism that holds the shopping cart basket in place on the elevated support structure of the shopping cart during shopping. At checkout, the shopping cart is pushed up to the conveyor belt of a checkout stand so that the distal portion of the shopping cart that hangs over the end of the elevated support structure extends over the proximal portion of the conveyor belt. The disengageable holding mechanism, if used, is then disengaged, and the shopping cart basket is pushed onto the conveyor belt.

In an implementation of the shopping cart, the shopping cart may carry a locking mechanism to detachably lock the shopping cart basket to the elevated support structure to prevent pilfering of the shopping cart basket when outside the store. The locking mechanism may be part of or associated with the disengageable holding mechanism described above.

In another implementation of the shopping cart, wheels or bearings may be carried by the elevated support structure and located underneath the shopping cart basket to facilitate pushing the shopping cart basket off of the elevated support structure and onto the conveyor belt.

In further implementations of the shopping cart, the shopping cart may include one or more support structures in addition to the shopping cart basket support to support one or more further shopping cart baskets or for carrying shopping items.

Another aspect of the invention involves an improved shopping cart for use at a store including a checkout stand having a surface at a height C for receiving shopping items. The shopping cart includes a shopping cart frame supported by a plurality of wheels for rolling the shopping cart around a store, a removable shopping cart basket supported by the shopping cart frame and including a bottom located at a height H that is above a height C of a surface of the checkout stand for receiving shopping items.

A still further aspect of the invention involves a method of using an improved shopping cart at a store including a checkout stand having a surface at a height C for receiving shopping items. The method includes providing an improved shopping cart including a shopping cart frame supported by a plurality of wheels for rolling the shopping cart around the store, a removable shopping cart basket supported by the shopping cart frame and including a bottom located at a height H that is above the height C of the surface of the checkout stand for receiving shopping items; and sliding the shopping cart basket from the shopping cart frame down onto the surface of the checkout stand for receiving shopping items.

Further objects and advantages will be apparent to those skilled in the art after a review of the drawings and the detailed description of the preferred embodiments set forth below.

### BRIEF DESCRIPTION OF THE DRAWINGS

FIG. 1 is a perspective view of an embodiment of an improved shopping cart located adjacent a conveyor belt system at a checkout stand.

FIG. 2 is a perspective view of the shopping cart of FIG. 1 with the detachable shopping cart basket detached from the shopping cart to show an elevated support structure of the shopping cart.

### DETAILED DESCRIPTION OF PREFERRED EMBODIMENTS

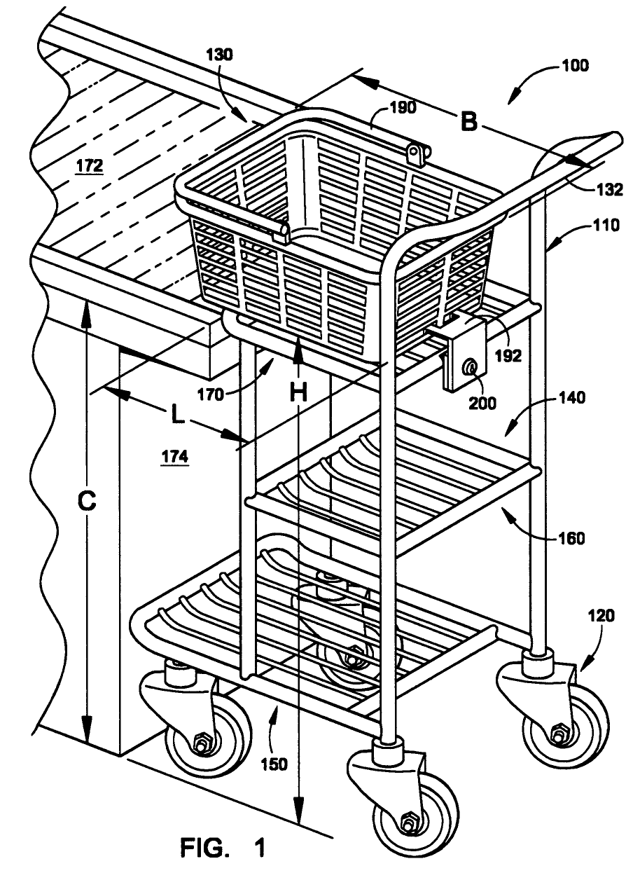

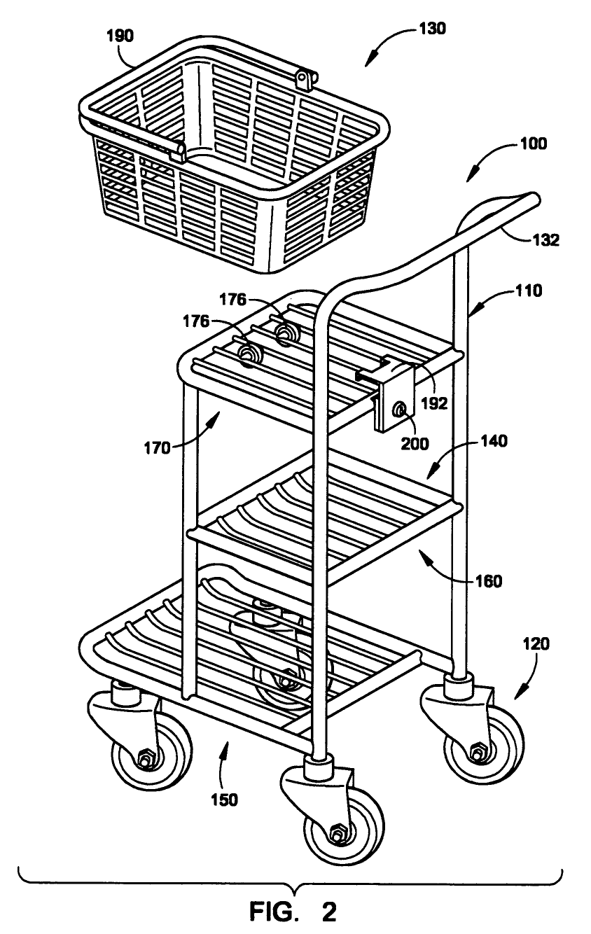

With reference to FIGS. 1 and 2, an improved shopping cart 100 constructed in accordance with an embodiment of the invention will now be described. The shopping cart 100 includes a shopping cart frame 110 supported by four casters or wheels 120 and a removable, detachable shopping cart basket 130 detachably supported by the frame 110.

The shopping cart frame 110 may be made of a metal or plastic material. The shopping cart frame 110 includes an upwardly and rearwardly extending rear handle 132 for pushing the shopping cart 100 and one or more optional lower support structures in the form of shelves or racks 140. In the embodiment shown, the one or more optional lower support racks 140 include a bottom support rack 150 adjacent the wheels 120 and an intermediate support rack 160. The one or more optional lower support racks 140 may be used to carry shopping items and/or one or more additional shopping cart baskets. An upper support structure in the form of an upper shelf or rack 170 supports the detachable shopping cart basket 130. The upper support rack 170 preferably includes a length L that is about ⅓ less than a length B of the basket 130 so that a distal portion of the basket 130 equal to about ⅓ the length of the basket 130 overhangs a distal end of the upper support rack 170.

The upper support rack 170 (and bottom of the removable shopping cart basket 130) is disposed at a height H that is slightly higher than the height C of a support surface such as, but not limited to, a conveyor belt 172 of a checkout stand 174. Although the support surface is described as a conveyor belt 172, it should be noted that the support surface may be a non-movable support surface or another type of support surface other than a conveyor belt 172. Further, the shopping cart 100 may used at any store where a shopping cart of some type might normally be used. This includes, but is not limited to, a grocery store. Other stores that the shopping cart 100 may be used at include, but not by way of limitation, electronics stores, computer stores, office equipment stores, home improvement stores, general merchandise stores, clothing stores, department stores, and bedding and linen stores.

Providing the upper support rack 170 (or bottom of the basket 130) at a height H slightly higher than the height C of the conveyor belt 172 at the checkout stand 174 and allowing a distal portion of the basket 130 to overhang the distal end of the upper support rack 170 makes it convenient and easy to push the basket 130 onto the conveyor belt 172 prior to checkout.

To further facilitate unloading the shopping cart basket 130 onto the conveyor belt, as shown in FIG. 2, one or more sliding mechanisms 176 (e.g., bearings, wheels) may be carried by the upper support rack 170 and located underneath the shopping cart basket 130 to facilitate pushing of the shopping cart basket 130 onto the conveyor belt.

The removable shopping cart basket 130 may be made of a metal wire, plastic, or other light-weight rigid material. The shopping cart basket 130 may include an optional handle 190 to assist in transporting the basket 130.

The shopping cart may include a disengageable holding mechanism 192 that holds the shopping cart basket in place on the upper support rack 170 of the shopping cart 100 during shopping. In the embodiment shown, the disengageable holding mechanism 192 is a latching arm; however, in alternative embodiments, other disengageable holding mechanisms such as, but not limited to, belts, straps, clamps, bars, hooks, clasps, prongs may be located underneath, to the side, and/or behind the basket 130 to detachably hold the basket 130 to the shopping cart 100.

An optional locking mechanism 200 may be used to lock the basket 130 to the frame 110 of the shopping cart 100 to prevent pilfering of the shopping cart basket 130. The locking mechanism 200 may be part of or associated with the disengageable holding mechanism 192 described above. The locking mechanism 200 may require a special key to lock and unlock the shopping cart basket 130 relative to the frame 110. In alternative embodiments, other types of locking mechanisms such as, but not limited to, combination locks may be used. The locking mechanism 200 may be unlocked prior to unloading of the shopping cart basket 130 onto the conveyor belt, and may be locked after checkout to prevent pilfering of the basket 130 when outside the store.

Exemplary use of the improved shopping cart 100 will now be described. During shopping, the shopper pushes the shopping cart 100 and the shopping cart basket 130 around the store and places shopping items into the shopping cart basket 130. In the embodiment of the shopping cart 100 shown in FIGS. 1 and 2, additional items such as bulkier items may be placed on the one or more lower support racks 140.

Often during shopping it is easier to walk over to one or more items and pick them up and bring them back to the cart without wheeling the shopping cart over to the items. If the one or more items are bulky enough, the shopper may remove the shopping cart basket 130, carry the basket 130 to the items using the handle 190, place the items in the basket 130 and return the basket 130 to the cart 100 during shopping.

Prior to checkout, the shopper simply pushes the shopping cart 100 up to the checkout stand 174, as shown in FIG. 1, so that the distal portion of the basket 130 hangs over the proximal portion of the conveyor belt 172. The disengageable holding mechanism 192, if used, is disengaged. Because the upper support rack 170 (or bottom of the basket 130) is at the height H that is slightly above the height C of the conveyor belt 172 and the distal portion of the basket 130 overhangs the proximal portion of the conveyor belt 172, pushing or sliding the shopping cart basket 130 onto the conveyor belt 172 is extremely simple and convenient. The conveyor belt 172 moves the basket 130 with shopping items to the cashier for checkout. The shopping items may be bagged and placed back into the basket 130 (or another empty basket 130) and the basket 130 with the bagged items may be placed onto the upper support rack 170 of the shopping cart 100, and the shopping cart 100 may be pushed out of the store to the user's automobile for unloading.

Alternatively, the shopping cart baskets 130 may be stacked and not removed from the store. Bagged items after checkout may be carried out of the store in the bags or may be placed on the one or more support racks or shelves of the shopping cart 100, and the shopping cart 100 may be pushed out of the store to the user's vehicle for unloading. The shopping cart 100 may be made in a multitude of configurations to accommodate different uses. For example, where the bags and packages of the checked-out items are placed on the shopping cart 100, without the shopping cart baskets 130, to transport to the user's vehicle for unloading, the shopping cart 100 may have one or more racks or shelves having a one-piece (e.g., solid) configuration or with small spaces between supports in the shelves to accommodate the bags and packages. Side edges of the one or more racks or shelves may be raised slightly to prevent the bags and packages from sliding off of the shopping cart 100. If the removable shopping cart baskets 130 are not to be taken out of the store, a store employee may take the baskets 130 that have been removed from the shopping carts 100 during checkout and position the removable shopping cart baskets 130 onto the respective shopping carts 100 for use by the prospective shoppers.

As discussed above, providing the upper support rack 170 (or bottom of the basket 130) at a height H that is slightly above the height C of the conveyor belt 172 and the distal portion of the basket 130 overhanging the end of the upper support rack 170 (and overhanging the proximal portion of the conveyor belt 172 when pushing the basket 130 onto the conveyor belt 172) makes it much easier for the shopper to unload shopping cart items onto the conveyor belt 172 than with shopping carts in the past. The shopper simply pushes or slides the entire shopping cart basket 130 with shopping cart items onto the conveyor belt 172. Not only is this easier and more customer friendly for the shopper, but it eliminates having to unload shopping items individually onto the conveyor belt and allows multiple shoppers to put their baskets 130 on the conveyor belt 172 at once. This allows more items to be placed on the conveyor belt 172 at once (because the items are confined in the baskets 130 and not spread out over the conveyor belt 172), is easier for the cashier, is less time-consuming, and results in shorter check-out lines.

It will be readily apparent to those skilled in the art that still further changes and modifications in the actual concepts described herein can readily be made without departing from the spirit and scope of the invention as defined by the following claims.

1. An improved shopping cart for use at a store including a checkout stand having a surface at a height C for receiving shopping items, comprising: a shopping cart frame supported by a plurality of wheels for rolling the shopping cart around the store, a removable shopping cart basket supported by the shopping cart frame and including a bottom located at a height H that is above a height C of the surface of the checkout stand for receiving shopping items.

2. The improved shopping cart of claim 1, wherein the frame includes a support surface to support the removable basket at the height H.

3. The improved shopping cart of claim 2, wherein the removable basket includes a distal portion and the support surface of the frame includes a distal end, and the distal portion of the removable basket overhangs the distal end of the support surface of the frame.

4. The improved shopping cart of claim 2, further including one or more support structures in addition to the support surface.

5. The improved shopping cart of claim 2, further including a sliding mechanism to facilitate sliding movement of the removable basket onto the surface of the checkout stand for receiving shopping items.

6. The improved shopping cart of claim 1, further including a disengageable holding mechanism to hold the removable basket to the frame.

7. The improved shopping cart of claim 1, further including a locking mechanism to lock the removable basket to the frame.

8. A method of using an improved shopping cart at a store including a checkout stand having a surface at a height C for receiving shopping items, the method comprising:
providing an improved shopping cart including a shopping cart frame supported by a plurality of wheels for rolling the shopping cart around the store, a removable shopping cart basket supported by the shopping cart frame and including a bottom located at a height H that is above the height C of the surface of the checkout stand for receiving shopping items;
sliding the shopping cart basket from the shopping cart frame down onto the surface of the checkout stand for receiving shopping items.

9. The method of claim 8, wherein the frame includes a support surface to support the removable basket at the height H.

10. The method of claim 9, wherein the removable basket includes a distal portion and the support surface of the frame includes a distal end, and the distal portion of the removable basket overhangs the distal end of the support surface of the frame, and providing an improved shopping cart includes pushing the improved shopping cart up to the checkout stand so that the distal portion of the removable basket overhangs the surface for receiving shopping items.

11. The method of claim 9, further including one or more support structures in addition to the support surface.

12. The method of claim 8, further including a sliding mechanism to facilitate sliding movement of the removable basket onto the surface of the checkout stand for receiving shopping items.

13. The method of claim 8, further including a disengageable holding mechanism to hold the removable basket to the frame.

14. The method of claim 8, further including a locking mechanism to lock the removable basket to the frame.
